(19) United States
(12) Patent Application Publication
(10) Pub. No.: US 2008/0166482 A1
(43) Pub. Date: Jul. 10, 2008

(54) Decorated Aluminum Surfaces and Methods of Producing Decorated Aluminum Surfaces

(76) Inventors: Robert D. Frye, Flowery Branch, GA (US); Wilfried Philipp, Kornwestheim (DE); Keith Moreau, Hillsboro, NH (US)

Correspondence Address: HAYES, SOLOWAY P.C., 175 CANAL STREET, MANCHESTER, NH, 03101, US

(21) Appl. No.: 11/620,864

(22) Filed: Jan. 8, 2007

(51) Int. Cl. B05D 3/10; B23P 9/00

(52) U.S. Cl. 427/327; 428/544; 428/687

(57) ABSTRACT

A device and a method for decorating an aluminum surface in a medical setting is provided. Generally the apparatus contains an aluminum surface adapted to be displayed in a medical setting and a digital image embedded within the aluminum surface. The method for decorating the aluminum surface in a medical setting generally includes choosing an aluminum surface, anodizing the aluminum surface, and printing a decoration on the aluminum surface.

### FIELD OF THE INVENTION

The present invention is generally related to decorated aluminum surfaces in a medical setting and to a method of producing decorated aluminum surfaces. More particularly, the present invention is related to decorated sterilized aluminum surfaces.

### BACKGROUND OF THE INVENTION

In an operative procedure medical instruments and materials for a medical procedure are laid out on a so-called Mayo Table or other surface so that they are readily accessible to a doctor. In a standard procedure the surface is a sterilized aluminum surface. Typically, aluminum surfaces in a medical setting are not decorated.

Currently, manufacturing methods for creating images on some aluminum surfaces are well known. For instance, credit cards, license plates, and consumer packaging are examples of products with aluminum surfaces with a printed decoration. The decoration on credit cards, for instance, are embossed in a plastic sheet material such as Mylar or another polyester which has a thin underlayer of reflective material such as aluminum to produce a reflective or holographic image. The aluminum is typically vapor deposited onto the credit cards.

It is also well known to emboss images directly onto the outer surface of sheet aluminum such as aluminum foil and aluminum beverage cans, as is disclosed in U.S. Pat. Nos. 4,773,718 and 4,725,111. These patents explain that the temperature of the aluminum is important for optimizing the embossing process.

It is well known that decorative printing can be obtained on many different surfaces using a pad or other similar printing process. However difficulties occur when printing on a smooth surface that has low roughness depth, such as a chromed or polished aluminum surface. Printing ink typically does not bond well to such surfaces and tends to flake off after a short period of use.

Thus, a heretofore unaddressed need exists in the industry to address the aforementioned deficiencies and inadequacies.

### SUMMARY OF THE INVENTION

Embodiments of the present invention provide an apparatus and method for decorating aluminum surfaces in a medical setting. Briefly described, in architecture, one embodiment of the method for decorating aluminum surfaces, among others, can be broadly summarized by the following steps: choosing an aluminum surface adapted for display in a medical setting, anodizing the aluminum surface, and printing a decoration on the aluminum surface.

The present invention can also be viewed as providing an apparatus for displaying a decoration on aluminum surfaces in a medical setting. In this regard, one embodiment of such an apparatus, among others, can be broadly summarized as comprising: an aluminum surface adapted to be displayed in a medical setting; and, a decoration embedded within the aluminum surface.

Other apparatus, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top view of a decorated aluminum surface, in accordance with a first exemplary embodiment of the invention.

FIG. 2 is a flow chart illustrating a method for decorating an aluminum surface in accordance with the first exemplary embodiment of the invention.

FIG. 3 is a perspective view of a printer printing on an aluminum surface, in accordance with the first exemplary embodiment of the invention.

FIG. 4 is a cross-sectional side view of a printed aluminum surface in accordance with a second exemplary embodiment of the present invention.

FIG. 5 is a top view of a printed aluminum surface in accordance with a third exemplary embodiment of the present invention.

FIG. 6 is another top view of the printed aluminum surface of FIG. 5 in accordance with the third exemplary embodiment of the present invention.

### DETAILED DESCRIPTION

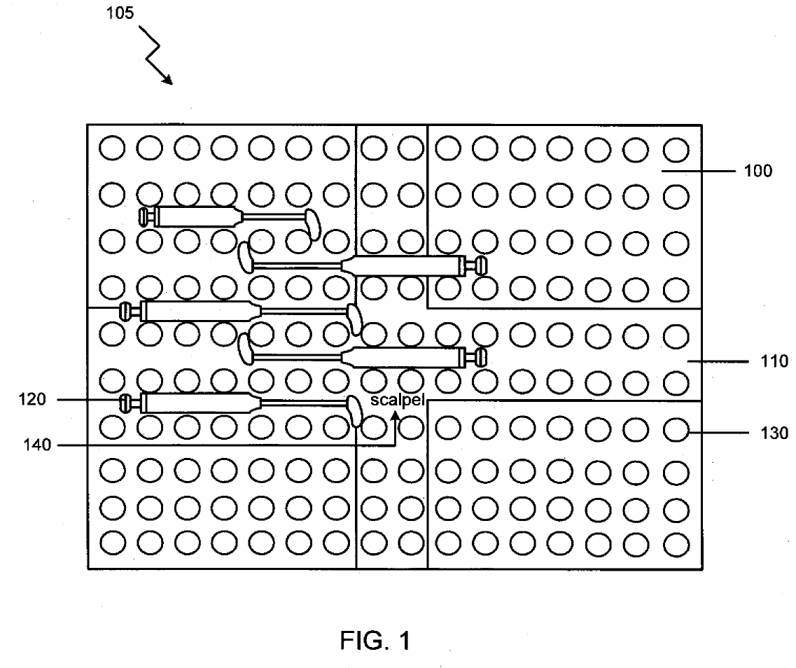

FIG. 1 is a top view of a decorated aluminum surface 100, in accordance with a first exemplary embodiment of the invention. More specifically, the aluminum surface 100 is an example of a part of an aluminum tray 105 that might be used to hold medical tools for sterilizing. The aluminum tray 105 has a decoration 110 embedded within the aluminum surface 100. As shown in the first exemplary embodiment, the decoration 110 is a cross shape, although the cross shape is an arbitrary design and the aluminum surface 100 may be embedded with any other conceivable design and still be considered to be within the scope of the present invention.

As an example of another possible decoration 110, the aluminum tray 105 of the first exemplary embodiment has five medical instrument decorations 120 embedded within the aluminum surface 100. The medical instrument decorations 120 may be provided such that a surgeon or other medical personnel will place a medical instrument in an organized, predetermined location on the aluminum tray 105. The aluminum tray 105 may be devised such that medical instruments may be attached to the aluminum surface 100, or an intermediary medical instrument holder that is connected to the aluminum surface 100. A plurality of apertures 130 are shown in the aluminum tray 105 that may allow the aluminum tray 105 to be sterilized without restricting the flow of water or retaining water after sterilization. The plurality of apertures 130 do not diminish the ability of the aluminum surface 100 to retain the decorations 110, 120 imprinted therein. In the embodiment shown, a character image 140 has been embedded into the aluminum surface 100 along with the decoration 110, illustrating that the printing system disclosed herein may be used for aesthetic/arbitrary decorations 110, purposeful decorations (such as the medical instrument decorations 120), and words, numbers, or other character images 140.

A decoration 110 in accordance with the present invention means any design, that may cover the whole or a part of the medical surface 100. The decoration 110 may be any size and shape desired and may be a digital design in accordance with the embodiments described.

According to the present invention, aluminum or other articles with low roughness depth that can be engraved, printed, or embossed in their surface are described. In particular and as shown in the figures, decorating aluminum surfaces 100 in a medical setting are described. Decorated aluminum surfaces 100 for instance, on wall claddings and tables are within the scope of the present invention. More specifically, decorating aluminum surfaces 100 for medical instruments in a medical setting are described in accordance with the present invention. In one embodiment decoration of sterilized medical surfaces, such as aluminum surfaces 100 made of hard temper aluminum alloys such as 3004 and H-19 aluminum are described.

As used herein, the terms “engrave,” “emboss,” “transfer” and “impress” mean the transfer of an image from one article or tool to another article or tool by pressing the articles or tools against one another under high pressure. The transfer is between the outer surface of the tools and articles.

Aluminum surfaces 100 in accordance with the present invention may have high specularity or brightness in order to produce a desired clarity of decoration 110. Aluminum is one of the most popular commodity surfaces for medical instruments because of its low specific weight, high mechanical stability and relatively high resistance to corrosion. Aluminum is characterized as a preferred metal in the embodiments described herein.

The material on which to be printed may have a preferred thickness of about 40 microns (um). However, the thickness of the material may range from about 30-50 um, and about 20-60 um. These material thicknesses are related to the thickness of aluminum useful for the construction of aluminum trays 105, and are not otherwise considered to be limitations on the practicability of the decorative methods disclosed herein for other products.

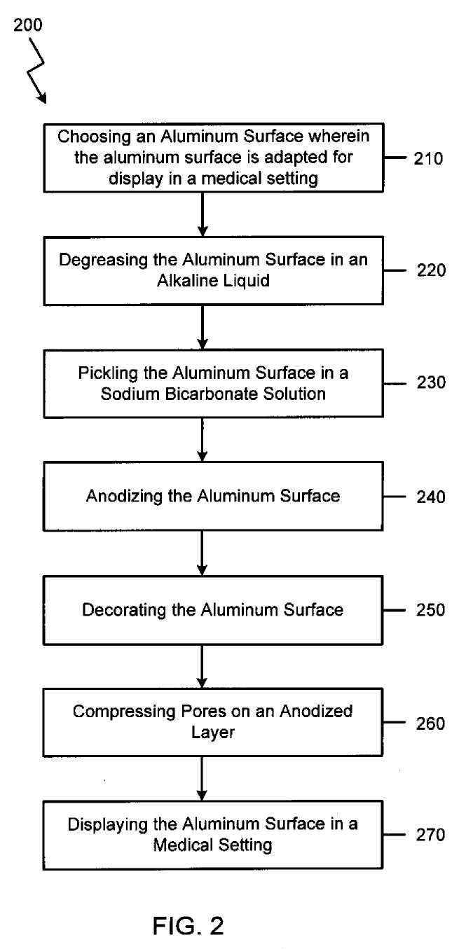

FIG. 2 is a flow chart 200 illustrating a method for decorating aluminum surfaces 100 in accordance with the first exemplary embodiment of the present invention. In a first step, choosing an aluminum surface 100 wherein the aluminum surface 100 is adapted for display in a medical setting is required (block 210). The shape and thickness of the aluminum surface 100 is important for determining the exact methods that will be followed to embed a decoration 110.

The aluminum surface 100 is degreased (block 220). The aluminum surface 100 may be degreased in an alkaline liquid. The alkaline liquid may be used to remove residual grease traces from the aluminum surface 100. Removal of particles and grease at this early stage in the method described is useful for providing a decorated piece that is substantially free of unwanted marks.

The aluminum surface 100 is pickled (block 230). Pickling is a process in which an acid solution is used to remove scale. The step of pickling may be performed using a sodium bicarbonate solution. In one embodiment of the present invention, the sodium bicarbonate solution ranges in concentration from about 40-50 g/l, from about 30-60 g/l and from about 20-70 g/l.

The choice of aluminum surface 100 to decorate plays a role in determining how long the pickling time is. Generally, the pickling time may be between about 30 seconds and 3 minutes. However, in some embodiments, depending on the size and shape of the aluminum surface 100, the pickling time may range from about 10 seconds and 4 minutes or from about 10 seconds and 5 minutes. For large industrial sized aluminum surfaces 100, the pickling time may range from about 5 minutes to 30 minutes.

### The Anodizing Process

The aluminum surface 100 is anodized (block 240). Anodizing occurs when a material is subjected to an electrolytic process, where natural oxidation has been controlled. Typically the process of anodizing involves immersing an aluminum surface 100 in a chemical bath and applying an electrical current to it, causing the aluminum to be converted into aluminum oxide. The layer of oxide hardens the aluminum surface 100, causing the aluminum to exhibit the following desirable properties: increased corrosion resistance, increased durability and wear resistance, the ability to be decorated through dying, electrical insulation, and the creation of an excellent base or primer for secondary coatings.

The shape and thickness of the aluminum material may be related to calculating how long an anodizing process should last. On average, in accordance with the present invention, an anodizing process may last about 2 minutes per um of aluminum thickness. However, the time for anodizing varies depending on the thickness of the aluminum material, the type of anodizing process used and the size of the aluminum material.

There are three main known processes for aluminum anodizing: chromic anodizing, sulfuric anodizing and hardcoat anodizing. Each of the aluminum anodizing processes may be used in accordance with the decorative methods of the present invention. Chromic anodizing uses a chromic acid electrolyte to yield a thin aluminum oxide layer, of about 0.05 to 0.1 mils of thickness. Chromic anodizing has been found as a useful submersion agent when the aluminum surface 100 exhibits a complex configuration, particularly when a surface is shaped such that the surface is difficult to rinse. Chromic anodizing also reduces fatigue strength of the aluminum as compared to other methods described herein.

Sulfuric anodizing typically coats an aluminum surface 100 to about 1 mil of thickness. Anodizing in sulfuric acid typically yields a more durable aluminum surface 100 with excellent corrosion resistance. One of the most desirable features of anodizing with sulfuric acid is that deep, rich colors can be embedded into the aluminum surface 100. In accordance with the present invention, richness of color may be one criteria for display of a decoration 110 on an aluminum surface 100. Hardcoat anodizing, on the other hand, uses a sulfuric acid electrolyte that results in a piece with improved wear resistance. Other methods of anodizing now known or later discovered may be used to anodize as disclosed herein and such other methods of anodizing are considered to be within the scope of the present invention.

In the first exemplary embodiment, sulfuric acid with a concentration range of between about 180-200 g/l is desirable. In other embodiments the sulfuric acid concentration may range from about 170-210 g/l and about 160-220 g/l.

In the first exemplary embodiment the aluminum surface 100 is decorated (block 250). After the anodizing process, the oxide layer has a porous nature that allows the aluminum to be dyed any color. The decoration 110 can be embedded into the oxide layer. The decoration 110 can be created using a commercially available digital imaging or drawing software.

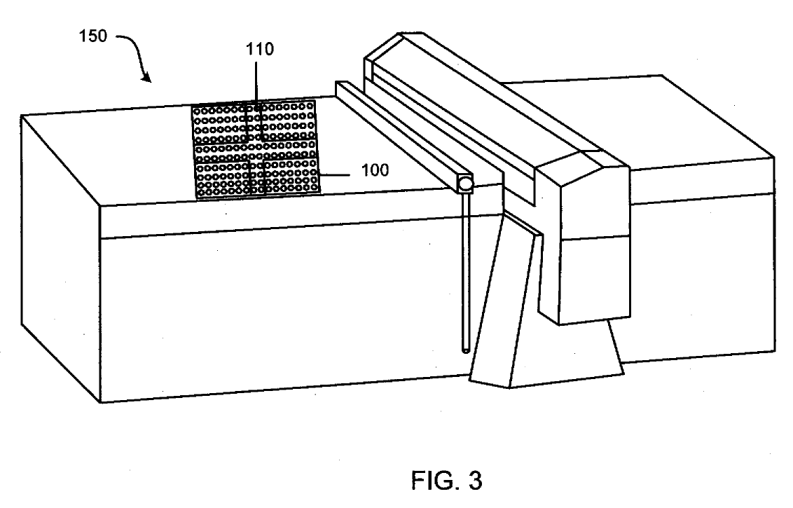

FIG. 3 is a perspective view of a printer 150 printing on an aluminum surface 100, in accordance with the first exemplary embodiment of the invention. The third exemplary embodiment of the present invention shows an example of a printer 150, for printing decorations 110 on the aluminum surfaces 100. In this embodiment, the decoration 110 is shown printing from printer 150. The print quality may be high resolution of up to about 1440 dpi. 3D images may also be created using a printer 150, resulting in the ability to make a decoration 110 in a variety of shapes and sizes.

In other embodiments water-based inks may be used in the printing process, which are generally safe for the environment. In addition a solvent-based ink may be used with a possible advantage that no heat may be needed when using this ink.

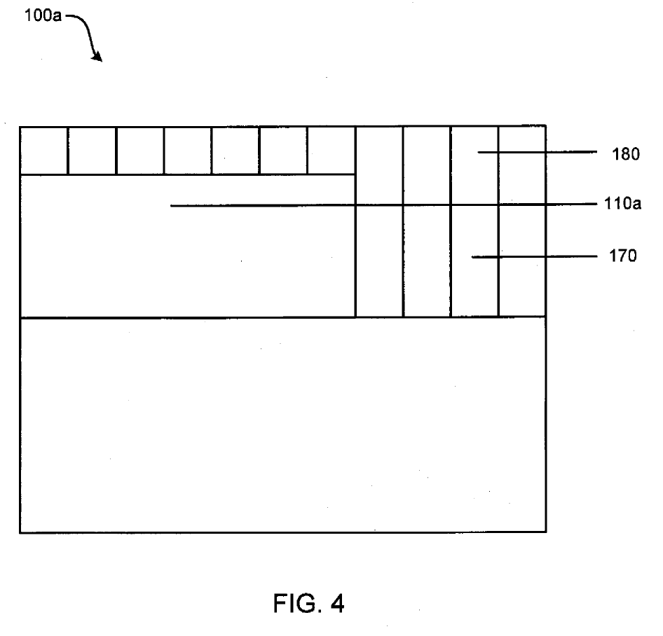

FIG. 4 is a cross-sectional side view of a printed aluminum surface 100a in accordance with a second exemplary embodiment of the present invention. The second exemplary embodiment shows an aluminum surface 100a in accordance with the present invention, showing an aluminum oxide layer 170 formed after the anodizing process. Decoration 110a is shown embedded within oxide layer 170, following the printing process. FIG. 4 also shows a top layer 180 of the oxide layer 170 acting as a protective layer to the decoration 110a. As discussed above, top layer 180 may provide increased corrosion resistance and increased durability and wear resistance to protect the decoration 110a. In accordance with the second exemplary embodiment the aluminum decoration 110a may be embedded at a depth of about 1 mil to about 42 mil.

Following the anodizing process and before the compression process, which will be discussed further herein, some effort may be desirable to avoid pressing the aluminum surface 100a because the pores are in an open position. While the pores are in an open position, the aluminum surface 100a is more susceptible to physical trauma than when the pores are in a closed position. Thus, following the anodizing step, the aluminum surface 100a may be sensitive and handling with care to prevent visible marks that may not be removable may be desirable.

### The Compression Process

Once the decoration 110a has been printed into the open pores of the anodized oxide layer 170 on the aluminum surface 100a, the pores on the anodized layer may be compressed (block 260). Compressing the pores on the anodized layer may involve: submerging the aluminum surfaces 100a in a water bath containing distilled water, heating the aluminum surfaces 100a from about 60° C. to about 95° C., leaving the aluminum surfaces 100a in the bath for about three minutes per micron of layer thickness, removing the aluminum surface 100a from the water bath, and cleaning the aluminum surface 100a. Addition of an element to prevent build up of a coating on the anodized layer may be a useful addition to the water bath. The selection of a cleaning agent may be determined by the residues that are left after the compression process. In order to remove significant traces of dirt and have a workably clean result, aggressive cleaning agents may be used.

Once the sheets have been fully compressed and cleaned, the aluminum surface 100a may be cut, have apertures punched, or otherwise shaped as desired. Water jet or laser cutters are suitable devices to carve or cut out an embedded picture on the aluminum surface 100a. Caution should be applied with regard to strong mechanical stress on the aluminum layer to prevent cracks from appearing in the anodized layer. Guillotine shears, for instance, which are known in the art for mechanically processing aluminum, may cause cracks to occur in the anodized surface if not properly maintained.

### Aluminum Surface Sterilization

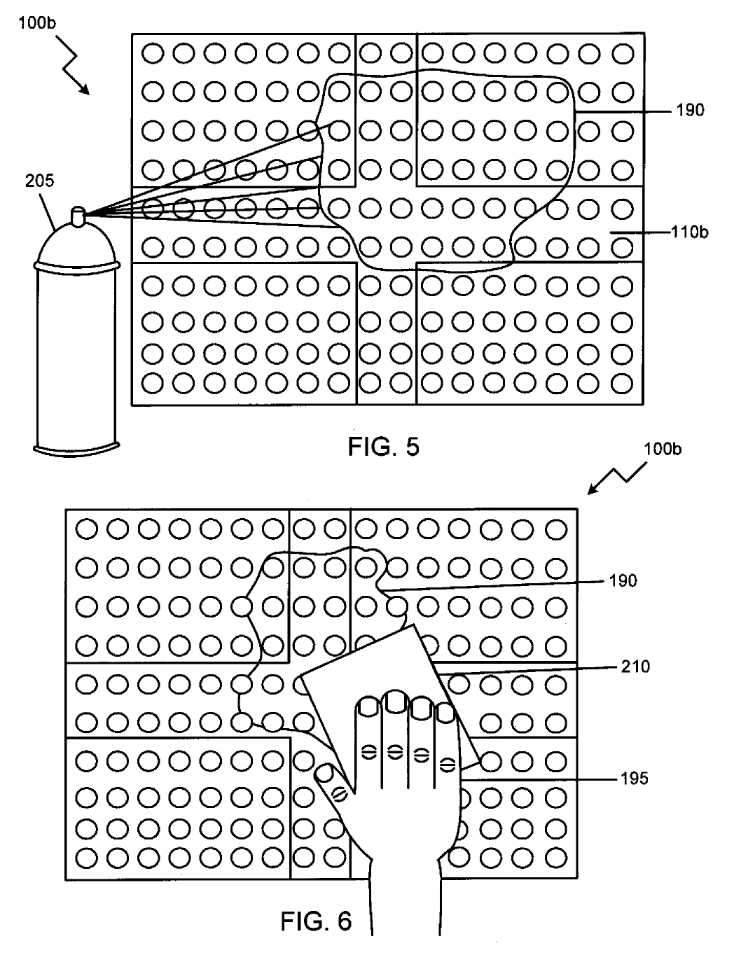

Anodized aluminum has many applications, including consumer products and industrial building materials. The durable, corrosion-resistant and lightweight aluminum may be used to embed a digital decoration 110a or other type of picture, image, or color pattern into an aluminum surface 100a that may be safely subjected to sterilization and disinfection agents 190, shown in FIG. 5 and FIG. 6 and described below.

In general, in a medical setting reusable medical instruments are placed on aluminum surfaces 100b, possibly at medical instrument decorations 120 (as shown in FIG. 1), as described in the embodiments herein. The ability to sterilize aluminum surfaces 100b without destroying an embedded decoration 110b is an important aspect of the present invention. Sterilization means the use of a physical or chemical procedure to destroy all microbial life, including highly resistant bacterial endospores. The major sterilizing agents used in a medical setting are moist heat by steam autoclaving, ethylene oxide gas, and dry heat. There are also a variety of chemical germicides or sterilants that are used for purposes of sterilizing medical surfaces. These sterilization methods will normally cause images or decorations on aluminum to fade or remove them in their entirety.

Disinfection of aluminum surfaces 100b in a medical setting is also commonly practiced. Disinfection means the use of a chemical procedure that eliminates virtually all recognized pathogenic microorganisms but not necessarily all microbial forms (e.g., bacterial endospores) on inanimate objects. There are three levels of disinfections: high, intermediate, and low. High-level disinfections kill all organisms, except high levels of bacterial spores, and is effected with a chemical germicide cleared for marketing as a sterilant by the Food and Drug Administration. Intermediate-level disinfections kills mycobacteria, most viruses, and bacteria with a chemical germicide registered as a “tuberculocide” by the Environmental Protection Agency (EPA). Low-level disinfections kill some viruses and bacteria with a chemical germicide registered as a medical disinfectant by the EPA.

The embedded decorations 110b in accordance with the present invention are durable and resistant to the sterilization and disinfection agents listed above. FIG. 5 is a top view of a printed aluminum surface 100b in accordance with a third exemplary embodiment of the present invention. The third exemplary embodiment shows an aluminum surface 100b in accordance with the present invention wherein spray can 205 is used to administer sterilization agent 190. Sterilization agent 190 is shown in this embodiment covering aluminum surface 100b in a cleaning procedure. In the embodiment shown, decoration 110b is embedded in aluminum surface 100b according to the methods described in accordance with the present invention. The decoration 110b is shown exhibiting resistance to damage from sterilization agent 190.

FIG. 6 is another top view of the printed aluminum surface 100b in accordance with the third exemplary embodiment of the present invention. FIG. 6 shows an embodiment in accordance with the third embodiment of the present invention wherein an aluminum surface 100b is embedded with a decoration 110b. In this figure, medical personnel 195 are able to simply use a wiping agent 210 to remove the sterilization agent 190 to clean the aluminum surface 100b. As indicated above, the embedded decoration 110b is durable and resistant to the sterilization agent 190 and can survive harsh cleaning agents, such as agents used for cleaning bodily fluids and bacteria off of a surface. In addition the cleaning process for medical personnel 195 is quick and easy, saving both time and money.

### Display of a Decorated Aluminum Surface

Displaying the aluminum surface 100a in a medical setting (block 270) is the last step for decorating an aluminum surface 100a in accordance with the second exemplary embodiment of the present invention. The purpose of the display may be to instruct medical personnel or patients to use medical instruments 120, to aesthetically please medical personnel, patients, and patrons generally, to create a distraction for children, to enforce medical codes and alarm signals, and for any other function for which a sign or other like device may be used in a medical setting. Displays may be in the form of medical trays, wall and table decorations, medical instruments, or any other suitable display in a medical setting. The displays are decorations 110a decorated into an aluminum surface 100a in accordance with the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for applying a decoration to an aluminum surface, the method comprising the steps of:
choosing the aluminum surface wherein the aluminum surface is adapted for display in a medical setting;
anodizing the aluminum surface; and,
printing the decoration on the aluminum surface.

2. The method in accordance with claim 1, further comprising a step of degreasing the aluminum surface.

3. The method in accordance with claim 2, further comprising the step of pickling the aluminum surface.

4. The method in accordance with claim 1, further comprising the step of compressing an anodized layer of the aluminum surface.

5. The method in accordance with claim 1, further comprising the step of cleaning the aluminum surface.

6. The method in accordance with claim 1, further comprising anodizing the aluminum surface using a concentration of sulfuric acid.

7. The method in accordance with claim 1, wherein the decoration is a digital image.

8. The method in accordance with claim 7, wherein the digital image is of a medical tool and wherein the aluminum surface is a portion of an aluminum tray, thereby visually defining an organized location for storage of the medical tool in the aluminum tray.

9. The method in accordance with claim 8 further comprising a step of degreasing the aluminum surface.

10. The method in accordance with claim 8 further comprising a step of pickling the aluminum surface.

11. The method in accordance with claim 8 further comprising the step of compressing an anodized layer of the aluminum surface.

12. The method in accordance with claim 8 further comprising the steps of cleaning the aluminum surface after the step of printing.

13. The method in accordance with claim 1, further comprising printing a digital image of a medical tool onto the aluminum surface, wherein the aluminum surface is a portion of an aluminum tray, thereby visually defining an organized location for storage of the medical tool in the aluminum tray.

14. The method in accordance with claim 1, further comprising the step of sterilizing the aluminum surface after the step of printing, wherein the decoration is substantially unaffected by the sterilization.

15. The method in accordance with claim 1, wherein the aluminum surface is at least a portion of a medical device and wherein the step of printing further comprises printing the decoration into the aluminum surface at a depth of at least about 1 mil to about 42 mil.

16. A method of applying a decoration to an aluminum surface comprising:
degreasing the aluminum surface;
pickling the aluminum surface;
anodizing the aluminum surface;
printing the decoration on the aluminum surface;
compressing an anodized layer on the aluminum surface; and,
cleaning the aluminum surface.

17. The method in accordance with claim 16, wherein the step of anodizing further comprises anodizing the aluminum surface with a concentration of sulfuric acid.

18. The method in accordance with claim 16, wherein the aluminum surface is at least a portion of a medical device and wherein the step of printing further comprises printing the decoration into the aluminum surface at a depth of at least about 1 mil to about 42 mil.

19. An apparatus for displaying a decoration, the apparatus comprising:
a medical tray used for the storage of medical tools, the medical tray having an aluminum surface; and,
a digital image embedded within the aluminum surface.

20. The apparatus in accordance with claim 19 wherein the depth of the digital image is at least about 1 mil to about 42 mil.

21. The apparatus of claim 19, wherein the digital image comprises an image of one of the medical tools, thereby visually defining an organized location for storage of the medical tool in the medical tray.

22. The apparatus of claim 21, wherein the medical tray is a sterilization tray.
